(19) United States
(12) Patent Application Publication
(10) Pub. No.: US 2010/0173551 A1
(43) Pub. Date: Jul. 8, 2010

(54) PRODUCTION OF NANOFIBERS AND PRODUCTS COMPRISED THEREOF

(76) Inventors: Suman Bretas Rosario Elida, Sao Paulo (BR); Guerrini Lilia Muller, Sao Paulo (BR); Thomas Gonzaga Canova, Santo Andre (BR)

Correspondence Address: BUCHANAN, INGERSOLL & ROONEY PC, POST OFFICE BOX 1404, ALEXANDRIA, VA, 22313-1404, US

(21) Appl. No.: 12/522,028

(22) PCT Filed: Jan. 4, 2008
(86) PCT No.: PCT/IB08/00009

§ 371 Date: Dec. 11, 2009

(30) Foreign Application Priority Data
Jan. 5, 2007 (FR) 07 00053

(51) Int. Cl. D04H 3/03; B29C 47/00; D01F 6/60; D02G 3/22

(52) U.S. Cl. 442/414; 264/465; 428/401; 977/961

(57) ABSTRACT

Nanofibers are produced by converting/electrospinning a solution of polyamides into nanofibers having a mean diameter ranging from about 40 nm to about 350 nm; products containing such nanofibers are useful as filters in particle systems, as separation membranes for the textile industry or in the cell or polar solvent industry, or as humidity sensors or the like, as well as for applications in the materials industry.

The present invention relates to a process for manufacturing a non-woven article that contains nanofibres and to a non-woven article containing such fibres. These articles are especially used in the filtration systems for fluids that contain particles or in the membrane separation systems used in the textile industry. These articles are more generally used in the textile industry.

The fibres obtained by electrospinning have a cross section with a dimension between 5 and 500 nm. The non-woven articles obtained with such fibres have a high specific surface area, which favours numerous applications such as, for example, use as a filter medium, separation membranes and as a component for the making of protective clothing. Many studies have been carried out on the conversion of polymers by electrospinning. Thus, document BR 0313222-6 describes the conditions for the electrospinning of amorphous, biodegradable polymers containing a biological agent (such as DNA, peptide, vaccine) for pharmaceutical applications.

According to document U.S. Pat. No. 4,044,404, solutions of polyamide 6/6 in formic acid are electrospun through an earthed syringe and by application of a negative voltage (−20 kV) to the collector. The polyamide concentration of the solutions used is between 0.10 g/cm³ and 0.16 g/cm³ and the diameter of the cross section of the fibres is between 0.70 μm and 2.8 μm. These micron-scale diameters are suitable for ultrafiltration, but are not suitable, for example, for the filtration of fluids comprising particles. Document U.S. Pat. No. 6,800,117 describes a solution, in a water/acetone mixture, of a nylon-6, nylon-6,6, nylon-6,10 copolymer which was electrospun onto a cellulose substrate. This polyamide copolymer cloth was used as a filter and for making clothing that protects against chemical attacks. However, it is difficult to synthesize the copolymers described in this patent. Document WO 2004/074559 describes a device for electrospinning a solution of polyamide PA-6 in a sulphuric acid/formic acid mixture in order to obtain, after conversion, a filament. This resulting filament has a good elongation property. Document US 2004/061253 describes an electrospinning system that applies a high voltage to the solution and also a high difference in voltage between the container of the solution and the earthed collector. This process makes it possible to obtain non-woven cloths comprising oriented nanofibres.

The present invention proposes an electrospinning process that allows, relative to the processes described:
i) the use of inexpensive, low toxicity solvents;
ii) nanofibres to be obtained with a cross-sectional diameter between 40 and 350 nm, and with a narrow diameter distribution; and
iii) the control of the molecular weight of the nylon-6,6 used by a post-condensation process.

As a consequence, the invention provides solutions to the three main problems encountered in polyamide PA-6,6 electrospinning processes:
i) the use of toxic and expensive solvents;
ii) the large micron-scale diameter of the fibres; and
iii) the control of the molecular weight of the polyamide suitable for the electrospinning processes.

Thus, use may be made of inexpensive solvents such as formic acid, which have a lower toxicity than that of the solvents customarily used, such as hexaisofluoropropanol. It is also possible to use mixtures of solvents such as acetic acid/formic acid, sulphuric acid/formic acid, ethanol/formic acid, hexaisofluoropropanol/dimethylformamide and formic acid/m-cresol mixtures.

The polyamides suitable for being put into solution have a number-average molecular weight advantageously between 10 000 g/mol and 50 000 g/mol, preferably between 18 000 and 50 000 g/mol.
In one particular embodiment, the polyamide solution may contain salts, for instance metal chlorides, such as for example, sodium chloride, aluminium chloride hexahydrate, magnesium chloride, ammonium chloride or iron chloride. This salt is advantageously present at a concentration between 5 mg/cm³ and 80 mg/cm³. In order to obtain nanofibres having a very small diameter, the concentration of salts will advantageously be between 25 mg/cm³ and 60 mg/cm³.
Advantageously, the polyamide solution of the invention does not comprise a supplementary polymeric organic additive.

The invention makes it possible to obtain a non-woven article composed of nanofibres having a diameter of the cross section between 40 and 350 nm. These articles or non-woven cloths may be used as separation membranes or a filter medium for systems comprising particles, cells, polar or non-polar solvents, filters, humidity sensors, for example. This manufacturing process may be used for producing large-size non-woven cloths by using a large-sized collector and several spinning syringes. In addition to an auxiliary conversion, as described in Patent WO 2004/074559, the process may be used for manufacturing nanofibres that enable the production of a continuous filament, presenting an advantage for the yarn and clothing market.

The polyamide nanofibres, especially polyamide PA-6,6 nanofibres, having a cross section between 40 and 350 nm are obtained by use of a metal electrode (for example, made of aluminium, brass, copper or alloys of these metals) immersed in the polyamide solution. The process is carried out with working distances between the needle and the collector of between 5 and 50 cm, needles having a diameter between 0.2 and 3 mm and a length between 10 and 50 mm. The rotational speed of the collector is between 5 and 300 rpm (revolutions per minute). The collectors are made of various metallic materials such as brass, aluminium, copper, stainless steel and alloys of these metals. The process is carried out with humidity conditions between 20% and 80%. The positive/negative voltage between the needle and the collector is between 5 and 50 kV, the collector advantageously being earthed. The collector is advantageously of cylindrical shape, but it may be a flat or curvilinear plate, a flat grid or the like. The duration of the spinning and of the collection on the roll may be between 1 second and 1 hour.

For obtaining the product containing nanofibres according to the invention, use is made of a method for electrospinning a polymer solution containing one or more polyamide homopolymers or copolymers, in the presence or absence of ionic salts, the solvent being an organic solvent. The polyamides suitable for the process of the invention advantageously have a number-average molecular weight between about 10 000 g/mol and about 50 000 g/mol, preferably between 18 000 and 50 000 g/mol. These polyamides are advantageously obtained with a solid or molten phase post-condensation step, preferably with a solid phase post-condensation step. The nanofibres obtained with the process of the invention have a cross section with an average diameter between about 40 nm and about 350 nm.

The process for electrospinning a polymer solution consists in applying an electrical potential difference between the solution and the collector surface in order to obtain non-woven articles or cloths composed of nanofibres having a nanometre-scale cross section. An electrode connected to a positive (or negative) high-voltage source is introduced into the polymer solution contained in a vessel equipped with a capillary. The solution is maintained, by its surface tension, in the form of a drop at the end of the capillary. Under the effect of the electric field generated by the electrical potential difference between the solution and the collector surface, the hemispherical surface of the drop stretches to form a cone, known as a Taylor cone. When the forces created by the electric field surpass the surface tension, a jet of solution is ejected from the cone. The solvent is evaporated during the flight of the jet between the end of the cone and the collector surface. Solidified nanofibres or nanofibril membranes are deposited on a collector. This collector may be a rotating drum covered with an electrically-conductive metal or with a grid made of an electrically-conductive metal. The collector is earthed.

The important implementation parameters of the process of the invention are:
the concentration of the polymer in the solution;
the electrical potential difference applied to the solution;
the effect of the addition of ionic salts to the solution;
the flow rate of the solution at the outlet of the capillary or needle and the distance between the end of the capillary and the collector.

Suitable polyamides are mainly polyamide homopolymers or copolymers, chosen from the group comprising: polyamides PA-6,6, PA-6, PA-6,10, PA-6,12, PA-11 and PA-12, blends or alloys thereof, and the copolymers of these polyamides, or derivatives. The preferred polyamide of the invention is polyamide PA-6,6.

The present invention makes it possible to manufacture non-woven articles or cloths comprising, in particular, polyamide PA-6,6 nanofibres having a diameter between 40 and 350 nanometres.

The main subject of this invention is the manufacture of cloths composed of nanofibres obtained by electrospinning solutions of polyamide PA-6,6 in solvents with optimal process parameters, especially the distance between the capillary and the collector surface, the potential difference applied between the solution and the collector, the presence of ionic salts in the solution, the polymer concentration of the solution, the form of the cloths, nanofibres and membranes obtained. These conditions are determined in order to obtain articles that are suitable for use in the production of filters, separation membranes, protective clothing or yarns.

The polymer solution suitable for the invention comprises polyamide PA-6,6 and an organic solvent. It additionally and advantageously comprises a salt in order to obtain articles or cloths formed with fibres of smaller or finer cross section. The solutions are characterized by the determination of the surface tension, the electrical conductivity and their rheology. The cloths obtained from these solutions have been studied by scanning electron microscopy, in particular in order to determine the average diameter of the microfibres.

In order to illustrate the invention, several tests have been carried out using a polyamide PA-6,6 with various number-average molecular weights varying between about 10 000 g/mol and about 50 000 g/mol. The various polyamides were obtained by solid-phase post-condensation in a vacuum oven at 160° C. Use was made, as solvent, of formic acid concentrated to about 85% and about 99% (expressed by volume). The solutions have a polymer concentration between about 25 mg/cm³ and 500 mg/cm³. Tests were carried out with these solutions but with the addition of an ionic salt, sodium chloride for example, at a concentration varying from about 5 mg/cm³ up to about 80 mg/cm³ to obtain cloths containing finer fibres.

It is also possible to use other solvents such as: hexaisofluoropropanol, acetic acid/formic acid, sulphuric acid/formic acid, ethanol/formic acid, hexaisofluoropropanol/dimethylformamide and formic acid/m-cresol mixtures, or else mixtures thereof. It is also possible to use other salts such as: sodium chloride, aluminium chloride hexahydrate, magnesium chloride, ammonium chloride and iron chloride, or mixtures thereof.

Various operating or processing parameters were used, such as:

a metal electrode immersed in the solution (the metal may be aluminium, brass, copper and alloys of these metals);

the distance between the end of the capillary and the collector varies from about 5 cm to about 50 cm;

the diameter of the needle or capillary varies between about 0.2 mm to about 3 mm;

the length of the needle varies between about 10 mm to about 50 mm;

the rotational speed of the collector varies between about 5 rpm to about 300 rpm;

various humidity conditions vary between about 20% to about 80%; and

positive or negative electrical potential differences vary between about 5 kV to about 50 kV.

The collector is formed from or comprises an outer surface made of an electrically-conductive metal, and may be chosen from the group comprising brass, aluminium, copper, stainless steels or alloys thereof. The collector used, which is earthed, is preferably of cylindrical shape. However, without departing from the scope of the invention, it may be of various shapes, such as in the form of a flat or curvilinear plate or a flat grid, for example.

The collector is preferably earthed, but a high positive or negative voltage (between 5 kV and 50 kV) may be applied to it instead of earthing it. The important feature of the process is that there is a high potential difference between the solution and the collector in order to generate electrical forces so as to obtain a cone at the outlet of the capillary and a jet of solution from this cone.
The collection time of the nanofibres on the collector may vary between one second and about one hour.

The product obtained by the process according to the invention is preferably in the form of a non-woven cloth or web.

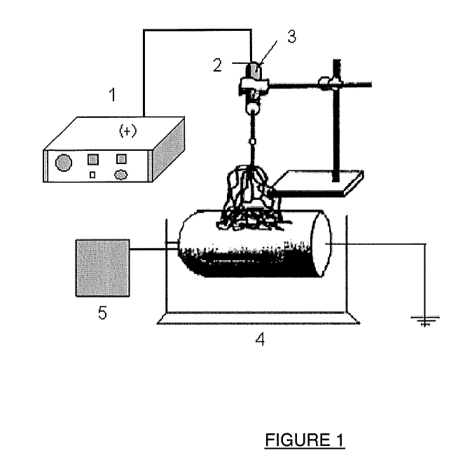

The appended FIG. 1 schematically illustrates one embodiment of a device for implementing the electrospinning process of the invention.

The device represented in this figure comprises:
a high voltage source (1);
a glass syringe or capillary (piston non illustrated) (2) with a cannula at its end;
an electrode made of a conductive metal (3); and
a collector (4).

A high (positive or negative) electric potential is applied to the solution of the polymer by means of the metallic electrode (3). The polyamide solution forms several jets of polyamide solution, generated at the outlet of the needle. The solvent evaporates between the end of the needle and the collector (4), which is earthed. The nanofibres are collected on the collector and form a non-woven cloth.

Examples will be described below in order to illustrate the invention, but under no circumstances should they limit the context and the scope of the latter.

### EXAMPLE 1

A solution of polyamide PA-6,6 with a number-average molecular weight of 15 500 g/mol in formic acid with a concentration of 150 mg/cm³ of polymer and 10 mg/cm³ of sodium chloride was introduced into a glass syringe and converted to nanofibres in an electrospinning device conforming to that represented in FIG. 1.

The solution is put into the syringe (2), a potential difference of 20 kV is applied between the solution or the syringe by the copper electrode (3) and the collector (4). The solution exiting the syringe forms jets which stretch out and which are collected on the collector, the solvent is evaporated during the flight of the jet. The length of the needle at the syringe outlet is 30 mm, the diameter of the orifice of the needle is 0.7 mm and its end is positioned 10 cm away from the surface of the collector.
The procedure is carried out for 20 minutes with a rotational speed of the cylinder of the collector of 23 rpm. The cloth thus formed on the collector is recovered.

### EXAMPLE 2

Example 1 is repeated but using a solution of polyamide PA-6,6 having a number-average molecular weight of 19 000 g/mol at a concentration of 170 mg/cm³ in the absence of ionic salt. The potential difference applied to the solution is 15 kV.

The length of the needle at the syringe outlet is 10 mm, the diameter of the orifice of the needle is 0.8 mm and its end is positioned 5 cm away from the surface of the collector.
The procedure is carried out for 10 minutes with a rotational speed of the cylinder of the collector of 15 rpm. The cloth thus formed on the collector is recovered.

### EXAMPLE 3

Example 1 is repeated but using a solution of polyamide PA-6,6 having a number-average molecular weight of 15 000 g/mol at a concentration of 150 mg/cm³ in the absence of ionic salt. The potential difference applied to the solution is 25 kV.

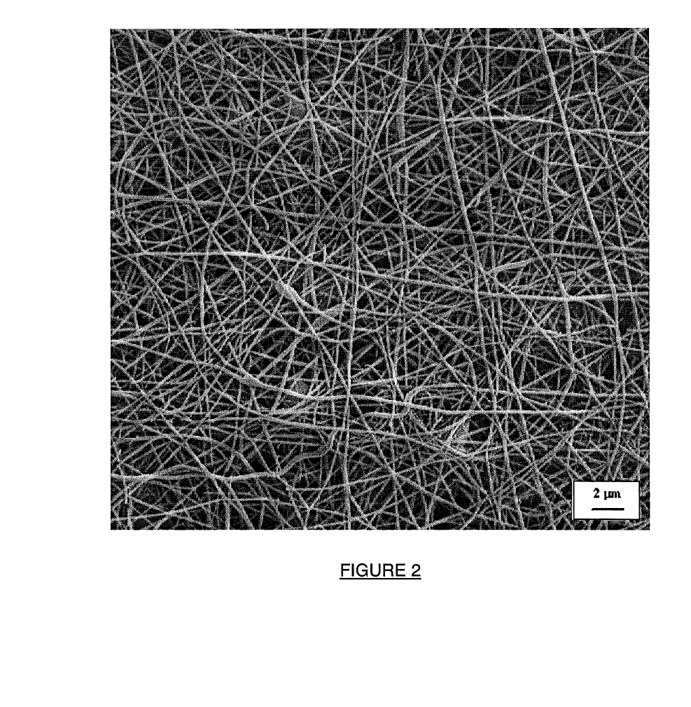

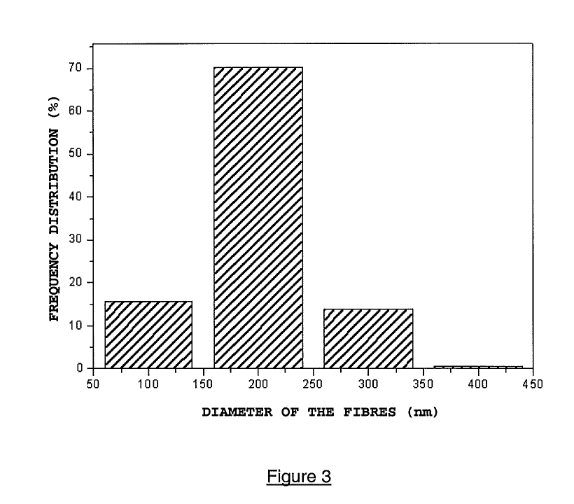

The length of the needle at the syringe outlet is 30 mm, the diameter of the orifice of the needle is 0.7 mm and its end is positioned 10 cm away from the surface of the collector.
The procedure is carried out for 15 minutes with a rotational speed of the cylinder of the collector of 20 rpm. The cloth thus formed on the collector is recovered.
The average diameter of the nanofibres that form the cloth recovered is 189 nm.
FIG. 2 is a microscope view illustrating the morphology and structure of the article obtained in Example 3.
FIG. 3 represents the distribution of the diameters of the nanofibres, illustrating the average of the diameters at 189 nm.

1.-24. (canceled)

25. A process for the production of nanofibers having an average diameter ranging from 40 nm to 350 nm, comprising electrospinning a solution of polymers containing one or more polyamide homopolymers or copolymers and, optionally, ionic salts, in the presence of an organic solvent, said polymers having number-average molecular weights ranging from about 10,000 g/mol to about 50,000 g/mol and then recovering said nanofibers on a collector.

26. The process as defined by claim 25, said solution of polymers comprising polyamides selected from the group consisting of polyamides PA-6,6, PA-6, PA-6,10, PA-6,12, PA-11 and PA-12, or blends thereof, or from copolymers or derivatives thereof.

27. The process as defined by claim 26, said polyamides comprising polyamide PA-6,6.

28. The process as defined by claim 25, said organic solvent being selected from the group consisting of formic acid, hexaisofluoropropanol, acetic acid and formic acid, sulphuric acid and formic acid, ethanol and formic acid, hexaisofluoropropanol and dimethylformamide, formic acid and m-cresol, and mixtures thereof.

29. The process as defined by claim 28, said organic solvent comprising formic acid.

30. The process as defined by claim 25, wherein the polymer concentration of the solution ranges from 25 mg/cm³ to 500 mg/cm³.

31. The process as defined by claim 25, said solution of polymers comprising salts selected from the group consisting of sodium chloride, aluminium chloride hexahydrate, magnesium chloride, ammonium chloride and iron chloride, and mixtures thereof.

32. The process as defined by claim 31, said salts comprising sodium chloride.

33. The process as defined by claim 31, wherein the concentration of salt in the solution ranges from 5 to 80 mg/cm³ of the solution.

34. The process as defined by claim 25, wherein said electrospinning is carried out by spinning the solution onto a collector, and applying a potential difference between the solution and the collector, including immersing a metal electrode into the solution.

35. The process as defined by claim 34, wherein the metal constituting the electrode is selected from the group consisting of aluminium, brass, copper and alloys thereof.

36. The process as defined by claim 34, wherein the solution is introduced into a syringe equipped with a needle and the distance between the end of the needle and the collector ranges from 5 to 50 cm.

37. The process as defined by claim 36, wherein the diameter of the needle ranges from 0.2 to 3 mm.

38. The process as defined by claim 36, wherein the length of the needle ranges from 10 to 50 mm.

39. The process as defined by claim 34, wherein the rotational speed of the collector ranges from 5 to 300 rpm.

40. The process as defined by claim 25, wherein the humidity of the medium ranges from 20% to 80%.

41. The process as defined by claim 35, wherein the positive or negative electrical potential difference between the solution and the collector ranges from 5 to 50 kV.

42. The process as defined by claim 25, wherein said collector comprises an electrically-conductive metal or comprises an outer layer of an electrically-conductive metal, the metal being selected from the group consisting of brass, aluminium, copper, stainless steel and alloys thereof.

43. The process as defined by claim 25, wherein said collector is in cylindrical, flat, curvilinear or flat grid form.

44. The process as defined by claim 43, wherein said collector is cylindrical in shape.

45. The process as defined by claim 25, wherein said collector is electrically grounded.

46. A non-woven article containing nanofibers, said nanofibers comprising polyamide nanofibers having an average diameter ranging from 40 nm to 350 nm.

47. A cloth or web comprising the nanofibers produced via the process as defined by claim 25.

48. A non-woven fabric comprising the nanofibers produced via the process as defined by claim 25.

49. Electrospun nanofibers having an average diameter ranging from 40 nm to 350 nm, comprising one or more polyamide homopolymers or copolymers, said polymers having number-average molecular weights ranging from about 10,000 g/mol to about 50,000 g/mol.
